(19) United States
(12) Patent Application Publication
(10) Pub. No.: US 2025/0103144 A1
(43) Pub. Date: Mar. 27, 2025

(54) GESTURES FOR NAVIGATING AND SELECTING ITEMS USING A LASER PROJECTED EPHEMERAL USER INTERFACE

(71) Applicant: Humane, Inc., San Francisco, CA (US)

(72) Inventors: Imran A. Chaudhri, San Francisco, CA (US); Bethany Bongiorno, San Francisco, CA (US); Kenneth Luke Kocienda, Mill Valley, CA (US); Joshua Dickens, Oakland, CA (US); George Kedenburg, III, San Francisco, CA (US); Yanir Nulman, San Francisco, CA (US); Pierluigi Dalla Rosa, Oakland, CA (US); Valerie Hau, San Jose, CA (US); Daniel Gobera, San Jose, CA (US); Edward Jiao, San Francisco, CA (US); Muhammad Akbar, San Francisco, CA (US); Joseph Cheng, Cupertino, CA (US); Sarah Parker, San Francisco, CA (US); Adam Binsz, San Francisco, CA (US)

(21) Appl. No.: 18/896,752

(22) Filed: Sep. 25, 2024

Related U.S. Application Data
(60) Provisional application No. 63/547,811, filed on Nov. 8, 2023.
(60) Provisional application No. 63/540,627, filed on Sep. 26, 2023.

(51) Int. Cl. G06F 3/01; G06T 7/20; G06T 7/50; G06V 10/70; G06V 40/10; G06V 40/20

(52) U.S. Cl. CPC G06F 3/017; G06F 3/011; G06T 7/20; G06T 7/50; G06V 10/70; G06V 40/10; G06V 40/28; G06T 2207/10028; G06T 2207/20081; G06T 2207/30196

(57) ABSTRACT

Embodiments are disclosed for gestures for navigating and selecting items using a laser projected ephemeral user interface (UI). Also disclosed is a multi-layer menu system that allows a user to select different menu layers by moving their hand towards or away from a depth sensor. Also disclosed is a depth picker control that display different elements of a 3D stack of elements in response to the user moving their palm towards or away from the depth sensor.

### CROSS-REFERENCE TO RELATED APPLICATIONS

This application claims priority to U.S. Provisional Patent Application No. 63/547,811, filed Nov. 8, 2023, and U.S. Provisional Patent Application No. 63/540,627, filed Sep. 26, 2023, the entire contents of which are incorporated herein by reference.

### TECHNICAL FIELD

This disclosure relates generally to interacting with ephemeral user interfaces.

### BACKGROUND

A wearable device, such as the wearable device disclosed in U.S. Pat. No. 10,924,651, for “Wearable Multimedia Device and Cloud Computing Platform with Application Ecosystem,” issued Feb. 16, 2021, includes a laser projection system that can project an ephemeral user interface onto a user's hand palm. With such a device it is desirable to present different virtual menus that contain different virtual affordances (e.g., icons, buttons) that can be navigated to and selected by the user using the same hand that is receiving the projection to free up the user's other hand to perform other tasks.

### SUMMARY

Embodiments are disclosed for gestures for navigating and selecting items using a laser projected ephemeral user interface (UI). In some embodiments, the ephemeral UI is projected onto a user's palm or other surface by a laser projector embedded in a wearable device attached to the user (e.g., attached to the user's clothing, resting in a front pocket, etc.). The wearable device includes a depth sensor, a camera and an infrared sensor for detecting gestures made by the user while interacting with the UI projected on the user's palm or other surface.

In some embodiments, the ephemeral UI is controlled by the user's palm where the location of an underlying (e.g., not displayed) cursor depends on the angle of the hand palm in three-dimensional (3D) space. A number of steps are used to compute an angle of the hand palm. First, using depth and infrared images captured by the depth and infrared sensors, respectively, the hand palm is detected with a machine learning (ML) model (e.g., a neural network). Next, 3D keypoints on the hand are predicted, where each keypoint corresponds to a different joint on the hand or a different point on the hand palm. The 3D keypoints are used to compute a surface normal vector that is perpendicular to the user's palm. The surface normal vector can be computed directly from the keypoints, or it can be computed using the depth image.

If the surface normal vector is computed using the depth image the following procedure is performed. From the 3D keypoints, corresponding points associated with the palm are extracted. These points create a region of interest that is used to determine what region in the depth image to extract depth values. Using the extracted depth values from the depth image and the location of the region of interest in 3D space, a plane is fit to the extracted depth values. A vector perpendicular to the fitted plane is computed as the normal surface vector.

For timepoint i, the normal surface vector is compared to a resting normal surface vector (e.g., subtracted from the resting normal surface vector). The difference is mapped to a two-dimensional (2D) plane that is mapped to a location on the ephemeral UI. In some embodiments, the difference can go through a function to control sensitivity of the difference to different directions and angles.

The final UI (x, y) location is used to determine the closest UI virtual affordance (e.g., a virtual button or icon). In some embodiments, the UI affordance is highlighted and/or animated to inform the user which UI affordance is currently focused on by the underlying cursor (i.e., surface normal vector). The user can select the UI affordance by, for example, making a pincer (“pinch and select”) gesture with their thumb and forefinger, or perform any other suitable gesture including but not limited to touching or hovering over the UI affordance.

The foregoing allows the user to focus an underlying cursor on a particular UI affordance projected on their palm by rotating their hand. For example, in some embodiments a set of UI affordances are projected in a circular pattern in the ephemeral UI. The user can rotate (tilt and roll) their hand in 3D space to highlight a particular UI affordance. This motion is similar to the classic children's ball-in-a-maze puzzle where a platform (the user's palm) is maneuvered (tilt and roll) to get a ball (the surface normal vector) to fall into a hole (point to a particular UI affordance projected on the user's hand palm).

In some embodiments, when the user first presents the palm of their hand in front of the depth and infrared sensors of the wearable device, a first menu (e.g., a main menu) is projected onto their palm that includes a first set of UI affordances. If the user pushes their hand out (further from the sensors), a second menu (e.g., a global menu) is projected onto their palm that includes a second set of UI affordances.

In some embodiments, a visual hint is provided in the ephemeral UI to inform the user that a second menu is available. An example visual hint is the presentation of icons in, for example, the corners of the ephemeral UI, which are animated into the distance to indicate the direction the user should move their hand (farther from or closer to the depth sensors) to access the second menu. For example, when the user moves their hand away from the depth sensors, the first set of UI affordances recede to the background and the second set of UI affordances are scaled up to consume more of the ephemeral UI.

In some embodiments, a 3D stack of virtual elements (also referred to herein as “depth picker control”) is animated in the ephemeral UI. In some embodiments, the 3D stack of virtual elements (e.g., cards) allows the user to pick discrete numbers and/or other characters while entering, for example, their passcode or a phone number. An element in the 3D stack is discretely picked by the user moving their palm towards or away from the depth sensors. For example, moving their palm away from the depth sensor selects virtual elements deeper/lower at the bottom of the stack, and moving their palm toward the depth sensor would select virtual elements at the top of the stack or vice-versa. In some embodiments, a combined direction and amount indicator (e.g., a stack of arrows) is projected proximate to the 3D stack of elements (e.g., projected underneath the virtual 3D stack of virtual elements) that indicates the direction and amount of remaining virtual elements in the virtual 3D stack in the indicated direction.

The details of the disclosed embodiments are set forth in the accompanying drawings and the description below. Other features, objects and advantages are apparent from the description, drawings, and claims.

### DESCRIPTION OF DRAWINGS

FIGS. 1A-1C illustrate the use of a pincer gesture to select an item for presentation in a laser projected ephemeral UI, according to or more embodiments.

FIG. 2 is a flow diagram of a process for navigating and selecting items from an ephemeral UI, according to one or more embodiments.

FIG. 3 is a flow diagram of surface normal estimation shown in FIG. 2, according to one or more embodiments.

FIGS. 4A and 4B illustrate conceptually how the surface normal projected into the 2D plane of the ephemeral UI is used to select a UI affordance, according to one or more embodiments.

FIGS. 5A-5E illustrate the use of animated visual indicators to indicate the availability of a second user interface layer, according to one or more embodiments.

FIGS. 6A-6C illustrate a depth picker control for selecting numbers and/or other characters, according to one or more embodiments.

FIG. 7 is a flow diagram of a process of navigating and selecting affordances in an ephemeral UI, according to one or more embodiments.

FIG. 8 is a flow diagram of a process for presenting a two-layer menu system, according to one or more embodiments.

FIG. 9 is a flow diagram of a process for implementing a depth picker control for selecting numbers and/or other characters, according to one or more embodiments.

FIG. 10 is device architecture for implementing the features and processes described in reference to FIGS. 1-9.

FIG. 11 is an example home page of an ephemeral UI, according to one or more embodiments.

FIGS. 12A and 12B are an example of menu navigation related to a “catch me up” affordance in the home page of FIG. 11, according to one or more embodiments.

FIG. 13 is an example date picker affordance, according to one or more embodiments.

FIGS. 14A and 14B are an example of menu navigation related to the listen affordance, according to one or more embodiments.

FIGS. 15A and 15B are an example of menu navigation related to the message affordance, according to one or more embodiments.

FIGS. 16A and 16B are an example of menu navigation related to a call affordance, according to one or more embodiments.

FIGS. 17A and 17B are an example of menu navigation related to a capture affordance, according to one or more embodiments.

FIGS. 18A-18C are an example of menu navigation related to a settings affordance, according to one or more embodiments.

FIGS. 19A and 19B are an example of menu navigation related to the “nearby” affordance shown in the home view of FIG. 1, according to one or more embodiments.

FIG. 20 is an example weather alert projection, according to one or more embodiments.

FIGS. 21A-21G are an example of menu navigation related to the listen affordance, according to one or more embodiments.

FIGS. 22A-22H are an example of menu navigation related to the message affordance, according to one or more embodiments.

FIGS. 23A-23H are an example of menu navigation related to photos, according to one or more embodiments.

FIGS. 24A-24E are an example of menu navigation related to phone calls, according to one or more embodiments.

FIGS. 25A-25G are an example of menu navigation related to WIFI settings, according to one or more embodiments.

FIG. 26 shows examples of menu navigation related to an “out of box” initialization process, including a quick setup process, according to one or more embodiments.

FIGS. 27A-27D show examples of menu navigation related to an “out of box” initialization process, according to one or more embodiments.

### DETAILED DESCRIPTION

### Pincer Gesture to Select Items for Display

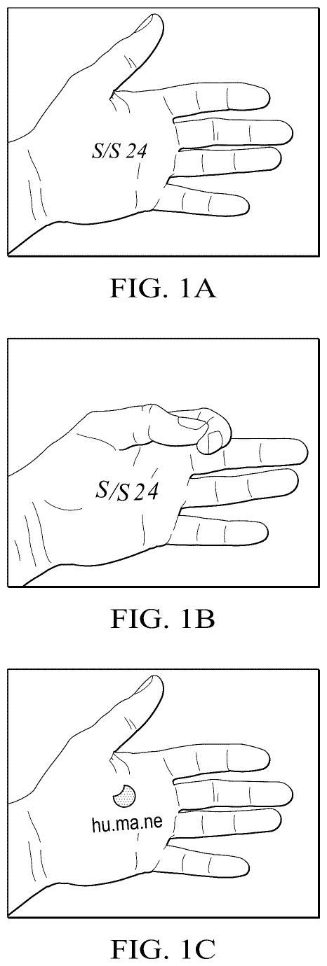

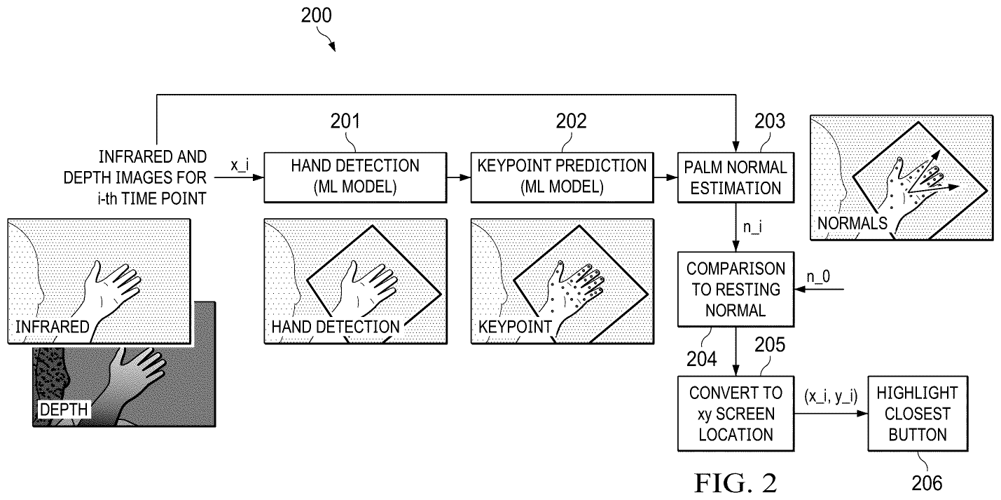

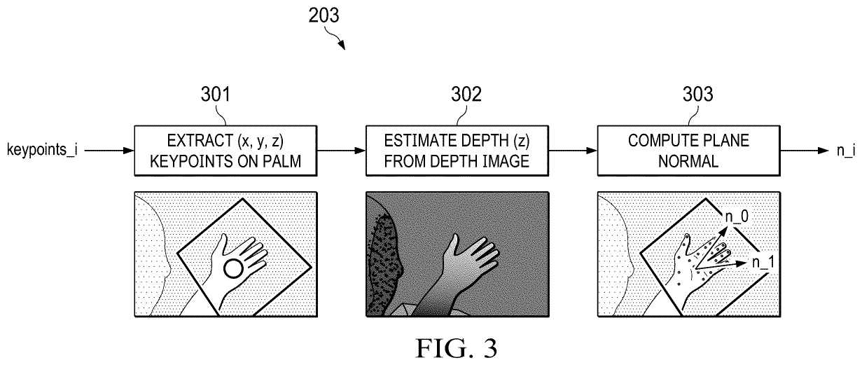

FIGS. 1A-1C illustrate the use of a pincer gesture to select an item for presentation in a laser projected ephemeral UI, according to or more embodiments. FIG. 1A shows a hand palm with a laser projection of an ephemeral UI. FIG. 1B shows the user making a pincer gesture by touching their forefinger and thumb. FIG. 1C shows the open hand palm with a different laser projection that was selected by the pincer gesture. The pincer gesture was detected by a depth sensor and infrared sensor as described more fully in reference to FIGS. 2 and 3.

### System Overview

FIG. 2 is a flow diagram of a process 200 for navigating and selecting items from an ephemeral UI, according to one or more embodiments. In some embodiments, the ephemeral UI is controlled by the user's palm where the location of an underlying (e.g., not displayed) cursor depends on the angle of the hand palm in three-dimensional (3D) space. A number of steps are used to compute an angle of the hand palm.

First, using depth and infrared images captured by the depth and infrared sensors, respectively, the hand palm is detected 201 with a machine learning (ML) model (e.g., a neural network). Next, 3D keypoints on the hand are predicted 202 (e.g., using a machine learning model trained on images of hand palms under various conditions), where each keypoint corresponds to a different joint on the hand or a different point on the hand palm. The 3D keypoints are used to estimate 203 a surface normal (e.g., a vector) that is perpendicular to the user's palm surface. The surface normal can be computed directly from the keypoints, or it can be computed using the depth image.

For timepoint i, the estimated normal surface vector is compared 204 to a resting normal surface vector (e.g., by subtracting estimated the normal surface vector from the resting normal surface vector). The difference is projected 205 to a two-dimensional (2D) plane that is mapped to a location on the ephemeral UI. In some embodiments, the difference can go through a function to control sensitivity of the difference to different directions and angles.

The final UI (x, y) location is used to determine 206 the closest UI virtual affordance (e.g., a virtual button or icon). In some embodiments, the UI affordance is highlighted and/or animated to inform the user which UI affordance is currently focused on by the underlying cursor (i.e., the surface normal projected in the 2D plane). The user can select the UI affordance by, for example, making a pincer gesture with their thumb and forefinger, or perform any other suitable gesture including but not limited to touching or hovering over the UI affordance.

FIG. 3 is a flow diagram of surface normal estimation 203 shown in FIG. 2, according to one or more embodiments. From the 3D keypoints, corresponding points associated with the palm are extracted 301. These points create a region of interest that is used to determine 302 the region in the depth image to extract depth values. Using the extracted depth values from the depth image and the location of the region of interest in 3D space, a plane is fit to the depth values. A normal perpendicular to the fitted plane is computed 303 as the surface normal. The surface normal can then be track frame to frame as the user tilts/rolls their hand to navigate affordances in the ephemeral UI.

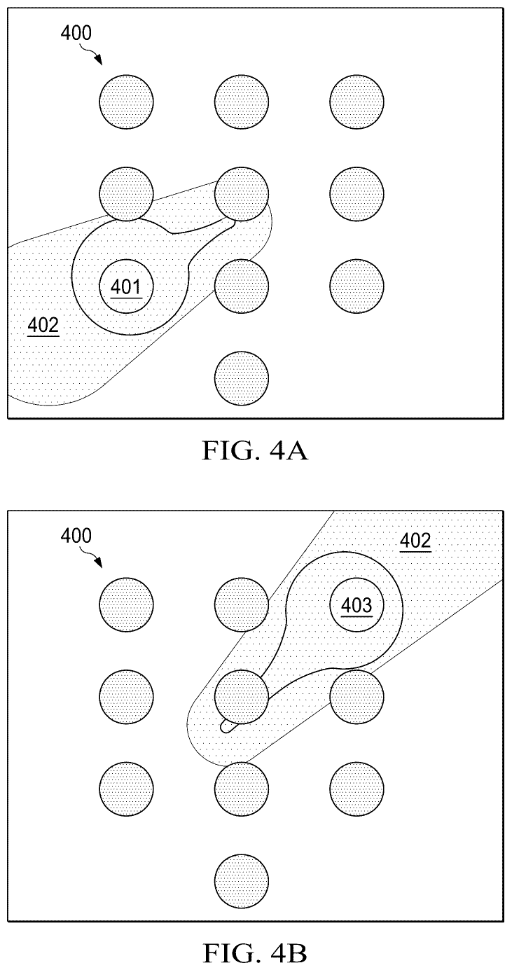

FIGS. 4A and 4B illustrate conceptually how the surface normal projected into the 2D plane of the ephemeral UI is used to select a UI affordance, according to one or more embodiments.

Referring to FIG. 4A, surface normal projection 402 is overlying affordance 401 in the 2D plane 400 of the ephemeral UI. This can occur when the user tilts and/or rolls their hand to move projection 402 over affordance 401. Affordance 401 becomes highlighted or animated to indicate to the user that the focus of the underlying cursor is affordance 401. When projection 402 overlies affordance 401, and the user makes a pincer gesture or other suitable gesture, affordance 401 is selected.

Referring to FIG. 4B, the user tilts/rolls their hand again to move the projection 402 over affordance 403 (referred to as “tilt and roll targeting”). Affordance 403 becomes highlighted or animated to indicate to the user the focus of the underlying cursor is affordance 403. When projection 402 overlies affordance 403, and the user makes a pincer gesture or other suitable gesture, affordance 403 is selected.

### Tilt and Roll Targeting

For tilt and roll targeting of a UI affordance as described above, there is an invisible cursor at the UI level (i.e., invisible to the user) that is driven by the tilt angle reported by the hand tracking described above. For example, when the user tilts their hand to select a UI affordance among a plurality of UI affordances projected on the ephemeral UI, the hand tilt angle is used to move the invisible cursor. When there are several UI affordances projected on the ephemeral UI, the UI affordance with the shortest distance to the invisible cursor position is focused, such that there is always a UI affordance that is focused by the invisible cursor. In some embodiments, the distance to each UI affordance is measured from the invisible cursor location to the perimeter of the affordance rather than the center of the UI affordance.

In some embodiments, when a user starts a pinching gesture, a gradual “focus locking” is applied, which makes the virtual touch area of the focused UI affordance larger. Focus locking is used to avoid accidentally focusing on a different UI affordance while trying to interact (e.g., click) with the currently focused UI affordance. In some embodiments, focus locking is based on the distance between fingers. In some embodiments, velocity of changes in the distance between fingers combined with distance is used for focus locking. For example, when the user starts moving towards pinching, the focus lock strength is increased. If the user stops the pinching motion, the focus lock is released, even if the user's fingers are close together. In some embodiments, a recent history of previously focused affordances is used to focus on a UI affordance that was focused on earlier (e.g., focused on a couple hundred milliseconds earlier). When an affordance is focused, it visually grows and extrudes towards the invisible cursor position. This provides continuous feedback to the user, since the extrusion keeps updating to point towards the cursor as the cursor moves.

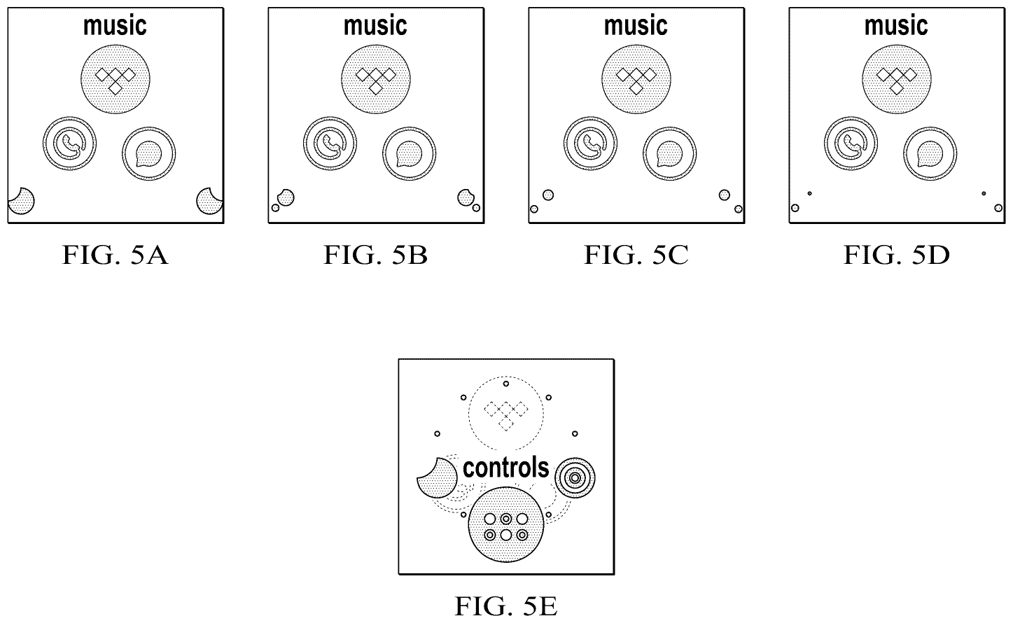

FIGS. 5A-5C illustrate the use of animated visual indicators to indicate the availability of a second user interface layer, according to one or more embodiments.

FIG. 5A shows an example first menu having three virtual UI affordances arranged on a circle. In the bottom corners are visual indicators. When the UI is initially projected on the user's palm or a surface, the visual indicators are full size as shown in FIG. 5A. After a short period of time (e.g., 0.5 seconds), the visual indicates are animated to recede into the background as shown successively in FIGS. 5B-5D. Accordingly, the visual indicators are present along enough to get the focus of the user, and by receding the user is given a clue that there is a second menu that is available at a lower layer then the first menu. If the user selects the visual indicator, the second menu is presented to the user in place of the first menu, as shown in FIG. 5E.

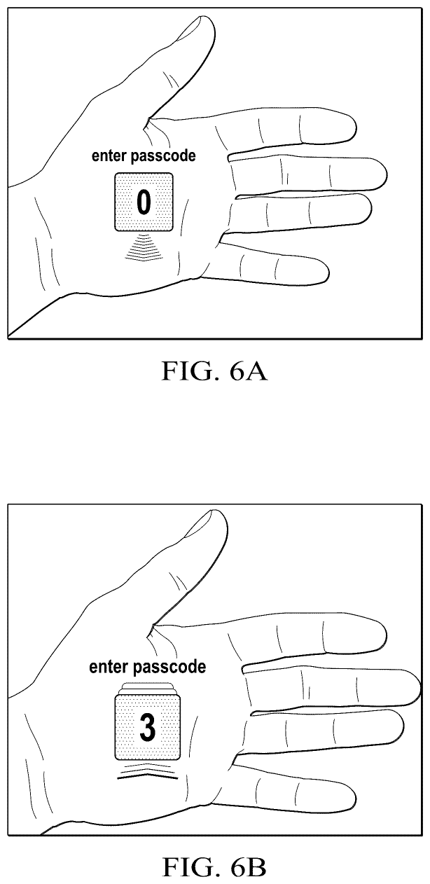

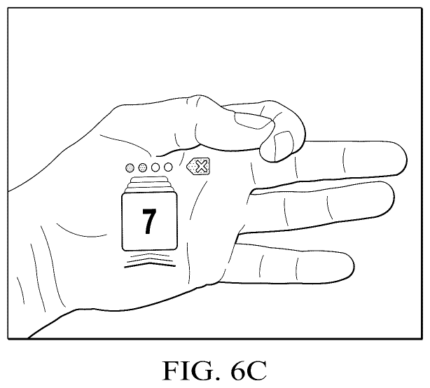

FIGS. 6A-6C illustrate a depth picker control for selecting numbers and/or other characters, according to one or more embodiments. In this example, a depth picker control is projected onto the hand palm of a user, and the user is entering a passcode. The depth picker includes a stack of elements for displaying values. The user can move up or down through the stack of elements by moving their hand relative to a depth sensor of the wearable device. Stacked arrows at the bottom of the depth picker indicate the direction and number of elements in the indicated direction. In the example shown, the user has selected the last element in the stack, and therefore the arrows are pointing in the direction of the depth sensor. This informs the user to move their hand towards the sensor to select a different element.

Referring to FIG. 6A, the first element is selected and displays a zero. The user moves their hand closer to the depth sensor to select a third element in the stack, and a three is displayed, as shown in FIG. 6B. Note that there 3 stacked arrows point away from the depth sensor, thus informing the user that if they move their hand away from the depth sensor there are three more elements that can be selected (i.e., 2, 1 and 0). The user then moves their hand even closer to the depth sensor to select a seventh element in the stack, and a seven is displayed as shown in FIG. 6C.

Although a passcode entry example is shown, the depth picker control can be used for entering any type of numerical or character information, such as a telephone number, street address, setting a clock or timer, entering monetary values, etc.

As described above, as the user pushes and pulls their hand the distance affects the Z depth in the virtual stack of elements. But if the hand distance is mapped to the Z depth on the stack of elements linearly, then small motions could translate to constant movement, creating perceived visual instability. Instead of linear mapping of the hand distance to the Z depth on the stack of elements, a function is used that produces a stepwise mapping. As the distance changes, at some point the user moves their hand to another step, which picks the next element on the stack. After that step, there is a distance deadband where the user can move their hand a bit without picking the next element in the stack until the user moves the hand beyond a distance threshold that picks the next element. In some embodiments, if while the user is pinching their hand moves accidentally to another element in the stack, the element that was previously picked (e.g., a couple hundred millisecond in the past) is picked again.

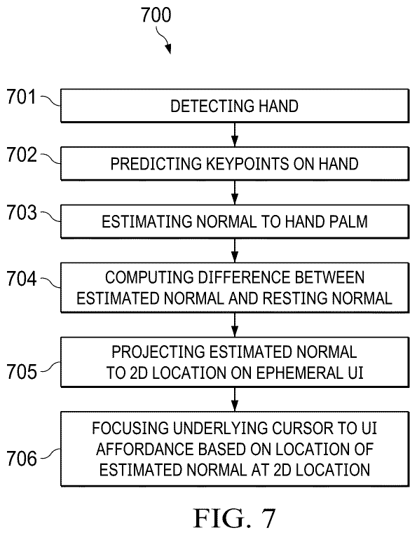

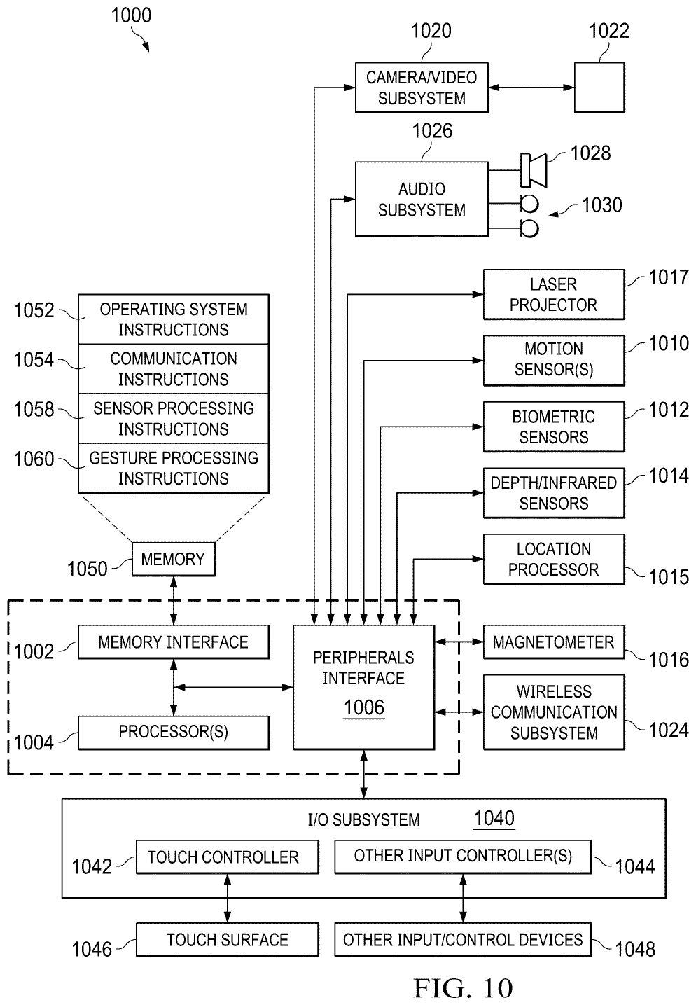

FIG. 7 is a flow diagram of process 700 of navigating and selecting affordances in an ephemeral UI, according to one or more embodiments. Process 700 can be implemented using the device architecture described in reference to FIG. 10.

In some embodiments process 700 includes: detecting, using a first machine learning model, a three-dimensional (3D) image of a hand based on depth images of the hand (701); predicting, using a second machine learning model, keypoints on the hand (702); estimating, based on the keypoints and depth images, a normal to a palm of the hand (703); computing a difference between the normal and a resting normal (704); projecting the difference into a two-dimensional (2D) plane of an ephemeral user interface projected on the user's hand palm (705); focusing an underlying cursor on an affordance in the ephemeral user interface based on a location of the projected difference (706); detecting a gesture made by the user's hand (707); and responsive to detecting the gesture, selecting the affordance (708).

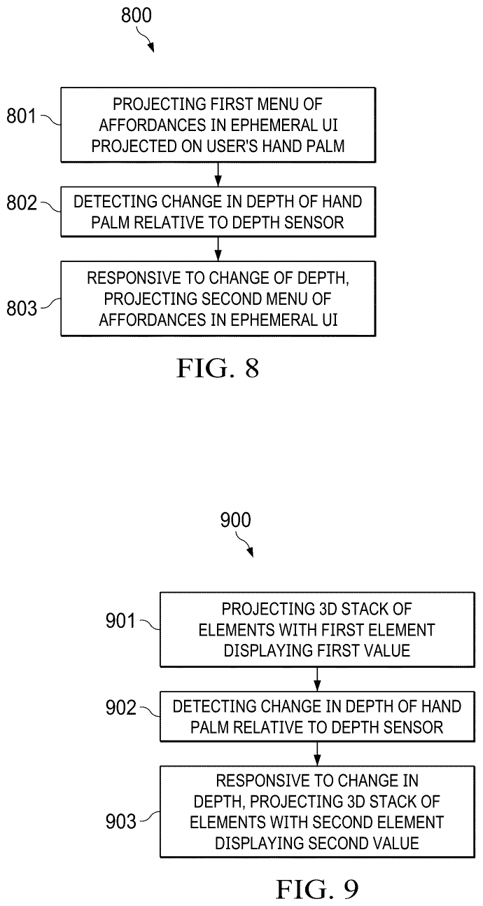

FIG. 8 is a flow diagram of a process for presenting a two-layer menu system, according to one or more embodiments. Process 800 can be implemented using the device architecture described in reference to FIG. 10.

In some embodiments, process 800 includes: projecting an ephemeral user interface onto a hand palm (801), the ephemeral user interface including a first set of affordances; detecting a change in depth of the hand palm relative to a depth sensor (802); and responsive to the change in depth, projecting a second set of affordances in the ephemeral user interface (803).

FIG. 9 is a flow diagram of a process for implementing a depth picker control for selecting numbers and/or other characters, according to one or more embodiments. Process 900 can be implemented using the device architecture described in reference to FIG. 10.

In some embodiments, process 900 includes: projecting a virtual stack of elements on a hand palm with a first element in the stack displaying a first value (901); detecting a change in depth of the hand palm relative to a depth sensor (902); and responsive to the change in depth, replacing the first element with a second element of the stack displaying a second value (903).

FIG. 10 is device architecture 1000 for implementing the features and processes described in reference to FIGS. 1-9. Device architecture 1000 can include memory interface 1002, one or more hardware data processors, image processors and/or processors 1004 and peripherals interface 1006. Memory interface 1002, one or more processors 1004 and/or peripherals interface 1006 can be separate components or can be integrated in one or more integrated circuits. Device architecture 1000 can be included in any wearable device with a laser projection system and gesture recognition system, such as the wearable device disclosed in U.S. Pat. No. 10,924,651.

Sensors, devices, and subsystems can be coupled to peripherals interface 1006 to provide multiple functionalities. For example, one or more motion sensors 1010, biometric sensors 1012 and depth/infrared sensors 1014 can be coupled to peripherals interface 1006 to facilitate motion sensing (e.g., acceleration, rotation rates), authentication and gesture recognition functions of the wearable device. Location processor 1015 can be connected to peripherals interface 1006 to provide geo-positioning. In some implementations, location processor 1015 can be a GNSS receiver, such as the Global Positioning System (GPS) receiver. Electronic magnetometer 1016 (e.g., an integrated circuit chip) can also be connected to peripherals interface 1006 to provide data that can be used to determine the direction of magnetic North. Electronic magnetometer 1016 can provide data to an electronic compass application. Motion sensor(s) 1010 can include one or more accelerometers and/or gyros configured to determine change of speed and direction of movement. Laser projector 1017 projects an ephemeral UI on a surface, such as a palm hand. Biometric sensors 1012 can be one or more of a PPG sensor, an electroencephalogram (EEG) sensor, an electrocardiogram (ECG) sensor, an electromyogram (EMG) sensor, a mechanomyogram (MMG) sensor (e.g., piezo resistive sensor) for measuring muscle activity/contractions, an electrooculography (EOG) sensor, a galvanic skin response (GSR) sensor, a magnetoencephalogram (MEG) sensor and/or other suitable sensor(s) configured to measure bio signals. Camera/video subsystem 1020 captures images with image sensor 1022.

Communication functions can be facilitated through wireless communication subsystems 1024, which can include radio frequency (RF) receivers and transmitters (or transceivers) and/or optical (e.g., infrared) receivers and transmitters. The specific design and implementation of the communication subsystem 1024 can depend on the communication network(s) over which a mobile device is intended to operate. For example, architecture 1000 can include communication subsystems 1024 designed to operate over a GSM network, a GPRS network, an EDGE network, a Wi-Fi network and a Bluetooth™ network. In particular, the wireless communication subsystems 1024 can include hosting protocols, such that the crash device can be configured as a base station for other wireless devices.

Audio subsystem 1026 can be coupled to a speaker 1028 and a microphone 1030 to facilitate voice-enabled functions, such as voice recognition, voice replication, digital recording, and telephony functions. Audio subsystem 1026 can be configured to receive voice commands from the user.

I/O subsystem 1040 can include touch surface controller 1042 and/or other input controller(s) 1044. Touch surface controller 1042 can be coupled to a touch surface 1046. Touch surface 1046 and touch surface controller 1042 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch surface 1046. Touch surface 1046 can include, for example, a touch screen. I/O subsystem 1040 can include a haptic engine or device for providing haptic feedback (e.g., vibration) in response to commands from processor 1004. In an embodiment, touch surface 1046 can be a pressure-sensitive surface.

Other input controller(s) 1044 can be coupled to other input/control devices 1048, such as one or more buttons, rocker switches, thumbwheel, infrared port, and USB port. The one or more buttons (not shown) can include an up/down button for volume control of speaker 1028 and/or microphone 1030. Touch surface 1046 or other controllers 1044 (e.g., a button) can include, or be coupled to, fingerprint identification circuitry for use with a fingerprint authentication application to authenticate a user based on their fingerprint(s).

In some implementations, the mobile device can present recorded audio and/or video files, such as MP3, AAC and MPEG files. In some implementations, the mobile device can include the functionality of an MP3 player. Other input/output and control devices can also be used.

Memory interface 1002 can be coupled to memory 1050. Memory 1050 can include high-speed random-access memory and/or non-volatile memory, such as one or more magnetic disk storage devices, one or more optical storage devices and/or flash memory (e.g., NAND, NOR). Memory 1050 can store operating system 1052, such as the iOS operating system developed by Apple Inc. of Cupertino, California. Operating system 1052 may include instructions for handling basic system services and for performing hardware dependent tasks. In some implementations, operating system 1052 can include a kernel (e.g., UNIX kernel).

Memory 1050 may also store communication instructions 1054 to facilitate communicating with one or more additional devices, one or more computers and/or one or more servers, such as, for example, instructions for implementing a software stack for wired or wireless communications with other devices. Memory 1050 may include sensor processing instructions 1058 to facilitate sensor-related processing and functions, such as instructs for operating depth/infrared sensors 1014. Memory 1050 further includes gesture processing instructions 1060 including but not limited to instructions for implementing the gesture processing features and processes described in reference to FIGS. 1-9.

### Example Menu Navigation Using Ephemeral UI

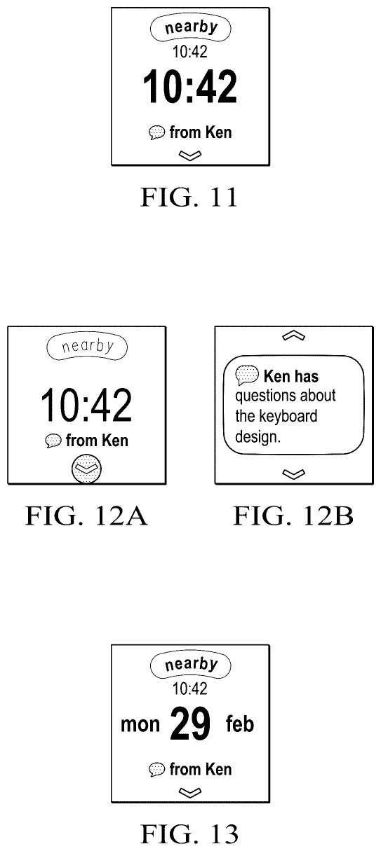

FIG. 11 is an example home view of an ephemeral UI, according to one or more embodiments. Home view 1100 includes a clock, a nearby affordance and a “catch me up” affordance, according to one or more embodiments. A home view is projected by the laser projection system of the device on the user's hand palm when the user raises their hand palm in front of the sensors (e.g., infrared camera, depth sensor) of the wearable device. The sensors recognize the open hand palm as a command to start the laser projection of the home view.

FIGS. 12A and 12B are an example of menu navigation related to a “catch me up” affordance in the home page of FIG. 11, according to one or more embodiments. Referring to FIG. 12A, the user selects the catch me up affordance by pitching their palm in front of the sensors so that the underlying cursor (described above) highlights the catch me up affordance. The user selects the “catch me up” affordance by making pincer gesture, as described in reference to FIG. 1B. In response to the selection, a first item of a virtual list of one or more items is projected. The items in the virtual list represent text messages and phone calls that have not been responded to by the user. If there are more than one item, the projection also includes arrow affordances, which can be selected by rolling or pitching the palm until the desired arrow affordance is highlighted, and selecting the arrow using the pincer gesture, where each pinch scrolls up or down the list depending on the arrow affordance selected. The item can be responded to by rolling and tilting to highlight the item in the ephemeral UI, and then using the pincer gesture to select the item. Selecting the item, results in a new projection showing the contents of the item and additional affordances for responding to the item, as described more fully below. In the example shown, there are more than one item in the virtual list as indicated by the arrow affordances, and a message from “Ken” is currently presented for selection using the pincer gesture.

As previously described, additional menus can be accessed by the user moving their palm (while in front of the sensors) further away from the sensors by a specified distance. In this example, there are two menus: a primary menu and a secondary menu. In other embodiments, there can more menus that are accessible. Hereinafter, the motion of the palm moving further away from the depth sensors is referred to as “pushing back” and the motion of the palm moving towards the depth sensor is referred to as “pulling forward.”

The depth sensor of the wearable device measures the distance to the palm where the primary menu is projected, and the distance is compared to a threshold distance. When the threshold distance is reached as the user pushes back, a secondary menu is projected that contains content related to content of the primary menu. The content can be predefined content, or it can be generated in real-time using an AI engine based on the context defined by the content of the primary menu, or a mixture of predefined and AI generated content. For example, if the primary menu is related to music, the secondary menu will also be related to music.

In some embodiments, there are two distance thresholds that trigger the presentation of the primary menu and second menu. In between the two threshold distances is a “dead zone” where the projection of the current menu is locked. For example, if the user pushes back to a first threshold distance to trigger presentation of the secondary menu, and then pulls forward, crossing the first threshold distance again (in the opposite direction), the projection of the secondary menu will remain presented on the user's palm, until the user pulls forward to a second threshold distance that is closer to the depth sensor than the first threshold sensor, at which point the primary menu is projected. The “dead zone” prevents unintended triggers of the primary or secondary menus based on unintended motion of the user's palm.

In some embodiments, a “crunch” gesture returns the user to the top menu of a particular hierarchy of menus. The “crunch” gesture is made by the user opening and then closing their hand. For example, if the user has navigated 3 menus deep by pushing back, the user can immediately access the home view 1100 with a “crunch” gesture. Other gestures could also be used.

FIG. 13 is an example date picker affordance that operates in accordance with the depth picker described in reference to FIGS. 6A-6C, according to one or more embodiments. In some embodiments, if the user selects the clock with the underlying cursor, the clock changes from a clock picker to a date picker, allowing the user to set the date in accordance with FIGS. 6A-6C.

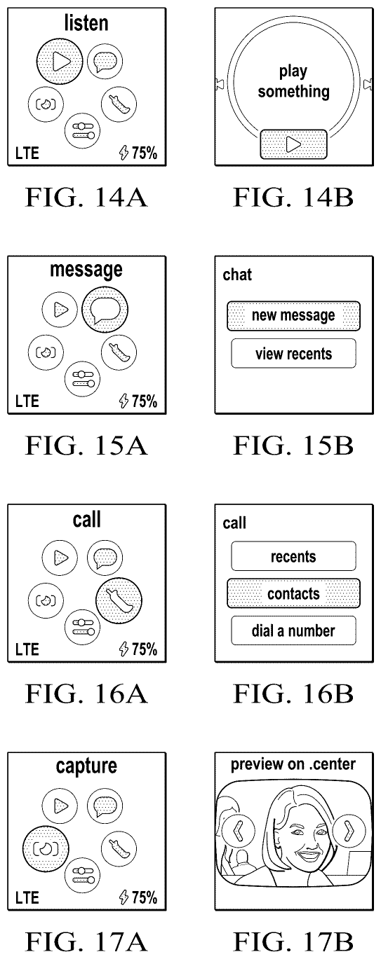

FIGS. 14A and 14B are an example of menu navigation related to the music affordance in the home page of FIG. 11, according to one or more embodiments. In some embodiments, pushing back reveals a secondary menu as shown in FIG. 14A. The example secondary menu includes a listen affordance, a message affordance, a call affordance, a settings affordance and a capture affordance. Each of these affordances can be highlighted for selection by moving the underlying cursor to select the affordance, i.e., by rolling and/or tilting the palm. In the example shown, the listen affordance is highlighted, and can be selected with a pincer gesture. FIG. 14B shows a projection in response to selection of the listen affordance and includes a play affordance that can be highlighted and selected using roll and/or pitch to highlight, followed by a pincer gesture to select the play affordance to start playing music or other audio content (e.g., a podcast).

FIGS. 15A and 15B are an example of menu navigation related to the message affordance, according to one or more embodiments. FIG. 15A shows the message affordance highlighted and FIG. 15B shows the resulting projection when the message affordance is selected. In this example, the user can select a new message or view recent messages by selecting the corresponding affordance using techniques previously described.

FIGS. 16A and 16B are an example of menu navigation related to the call affordance, according to one or more embodiments. FIG. 16A shows the call affordance highlighted and FIG. 16B shows the resulting projection when the call affordance is selected. In this example, the user can select from recent, contacts or dial a number by selecting the corresponding affordance using techniques previously described.

FIGS. 17A and 17B are an example of menu navigation related to the capture affordance, according to one or more embodiments. FIG. 17A shows the call affordance highlighted and FIG. 17B shows the resulting projection when the capture affordance is selected. In this example, the user can scroll images captured by the wearable device camera by highlighting and then selecting the appropriate navigation arrow affordance using techniques previously described.

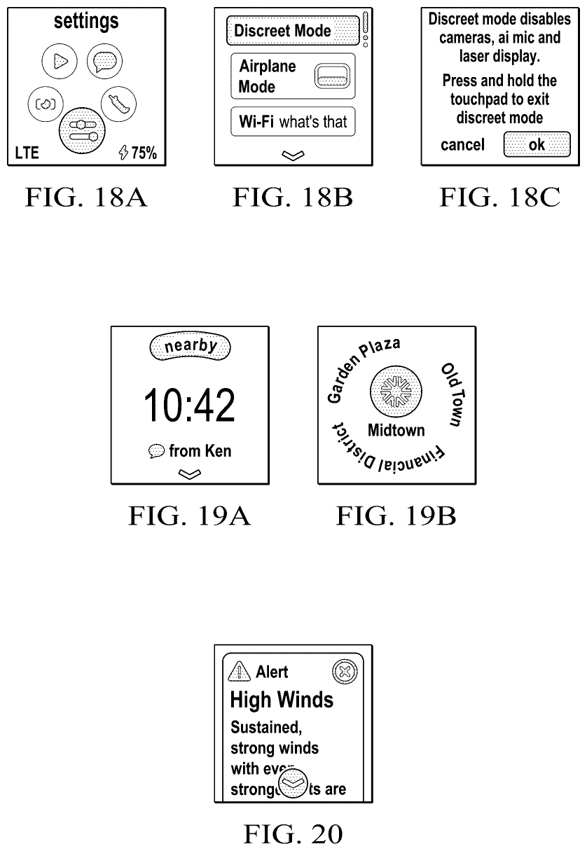

FIGS. 18A-18C are an example of menu navigation related to settings affordance, according to one or more embodiments. FIG. 18A shows the settings affordance highlighted and FIG. 18B shows the resulting projection when the settings affordance is selected. In this example, the user can select airplane mode to turn on/off the wireless communication of the wearable device, WIFI for managing WIFI settings (e.g., entering a WIFI passcode) and turn on/off a discrete mode, which when turned on disables the cameras, microphone and laser display to, for example, protect the user's privacy and/or the privacy of others. Each of these settings affordances can be highlighted and then selected using techniques previously described. FIG. 18C shows the resulting projection when discrete mode is selected.

FIGS. 19A and 19B are an example of menu navigation related to the nearby affordance shown in the home view of FIG. 11, according to one or more embodiments. FIG. 19A shows the home view with the nearby affordance highlighted. When the nearby affordance is selected, the resulting projection is shown in FIG. 19B. FIG. 19B includes the names of nearby destinations of interest around the user's current location, as determined by, a GNSS receiver or other location technology of the wearable device. In this example, names of local neighborhoods are shown. Selecting a neighborhood affordance results in additional menus/projections associated with the neighborhood (e.g., popular restaurants, landmarks, etc.).

FIG. 20 illustrates a weather alert projection that is projected in response to a weather alert from, for example, a weather bureau subscribed to by the wearable device and based on the current location of the wearable device. In the example shown an arrow affordance can be selected to scroll to additional weather information.

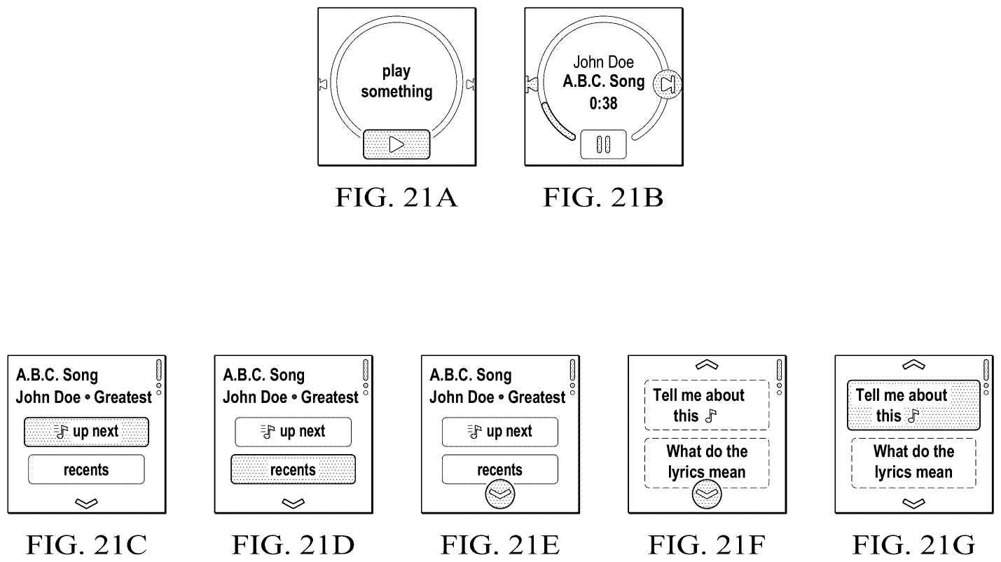

FIGS. 21A-21G are an example of menu navigation related to music affordance, according to one or more embodiments. Each figure shows an example menu projection that is part of a menu hierarchy related to music.

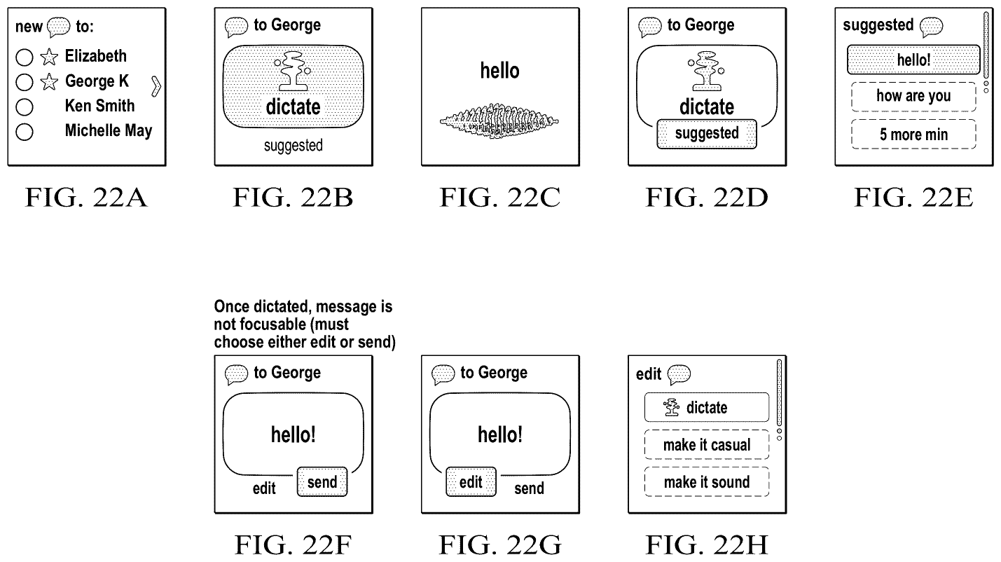

FIGS. 22A-22H are an example of menu navigation related to messages, according to one or more embodiments. Each figure shows an example menu projection that is part of a menu hierarchy related to messages (e.g., dictation, editing and sending a message, etc.).

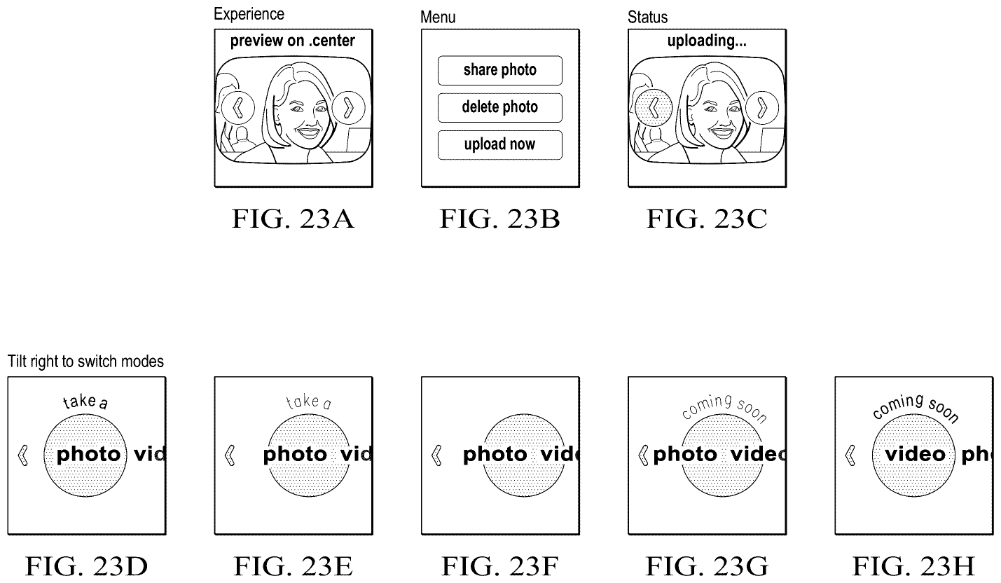

FIGS. 23A-23H are an example of menu navigation related to photos, according to one or more embodiments. Each figure shows an example menu projection that is part of a menu hierarchy related to photos (e.g., viewing, sharing, deleting, uploading photos or video clips, etc.).

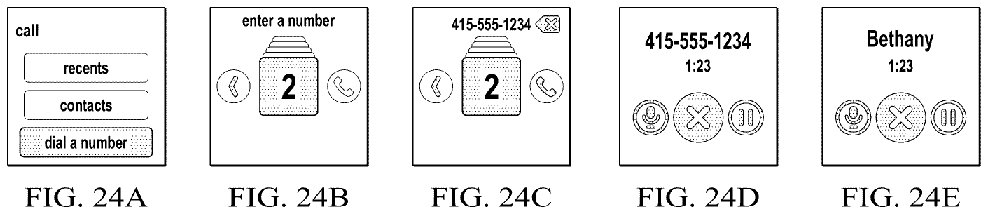

FIGS. 24A-24E are an example of menu navigation related to phone calls, according to one or more embodiments. Each figure shows an example menu projection that is part of a menu hierarchy related to phone calls (e.g., entering and dialing a phone number; playing, pausing or deleting voicemails, etc.)

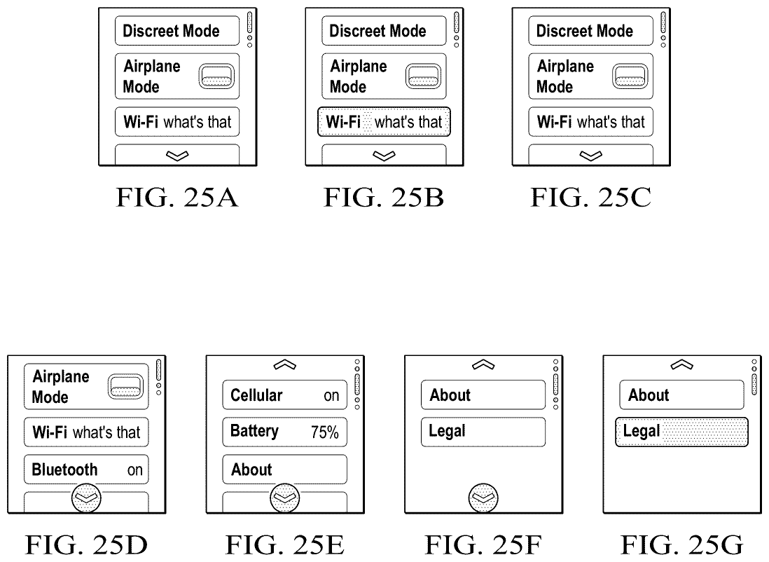

FIGS. 25A-25G are an example of menu navigation related to WIFI settings, according to one or more embodiments. Each figure shows an example menu projection that is part of a menu hierarchy related to WIFI (e.g., discrete mode, airplane mode, etc.)

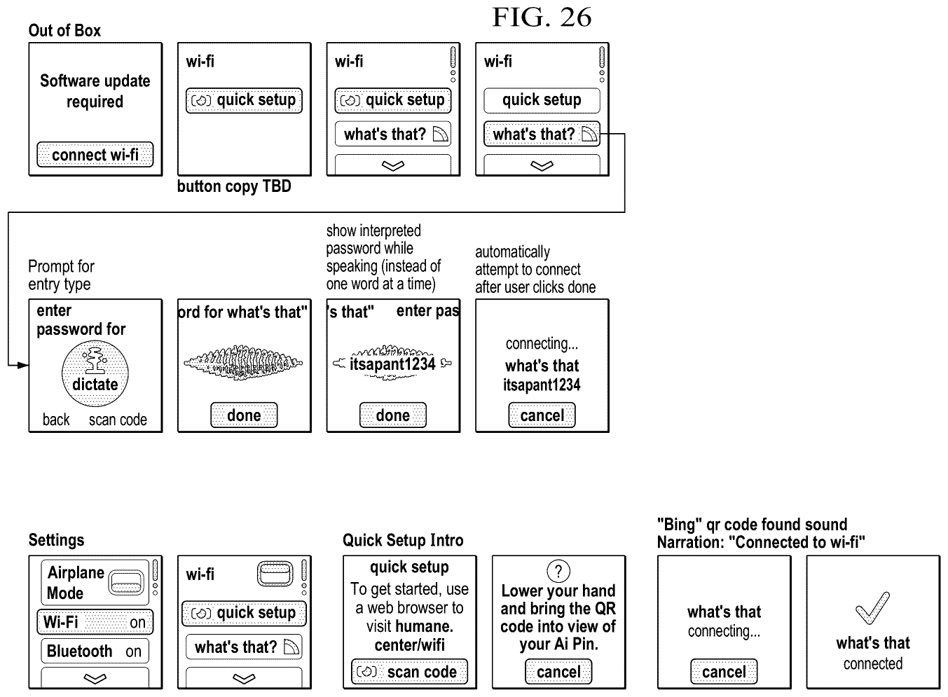

FIG. 26 illustrates an example of menu navigation related to an “out of box” initialization process for the wearable device, according to one or more embodiments. Some examples of “out of the box” menus include performing a quick setup process, which allows the user to dictate their WIFI passcode using a microphone of the wearable device. The audio capture of the passcode is used to generate a QR code with the WIFI password encoded therein, so that the user can enter the WIFI passcode by simply scanning the QR code with the camera of the wearable device. This avoids having to use a number picker affordance on in a laser projection to enter a lengthy passcode with a combination of number, characters and symbols.

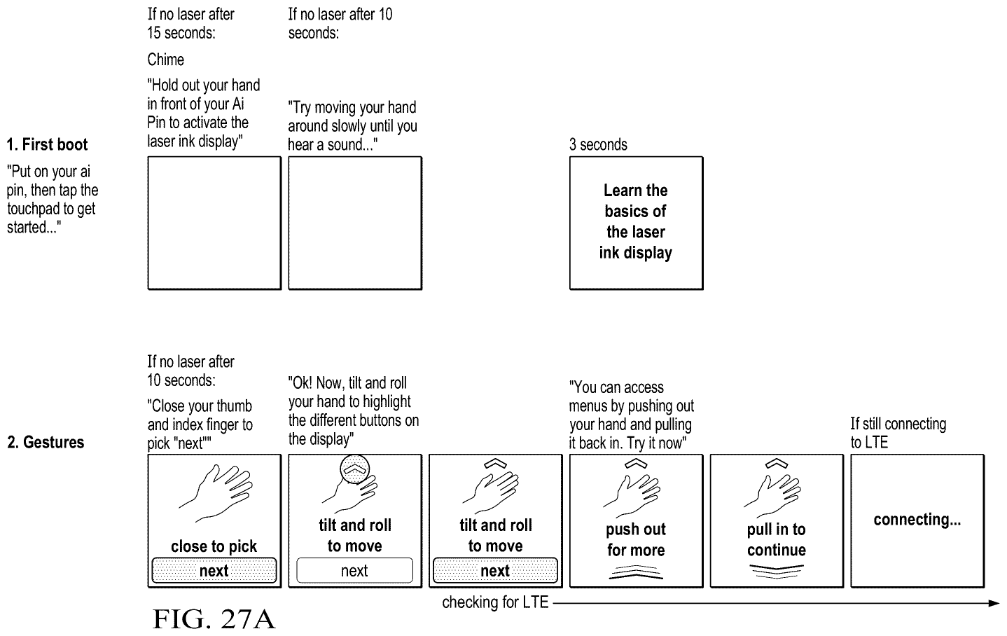

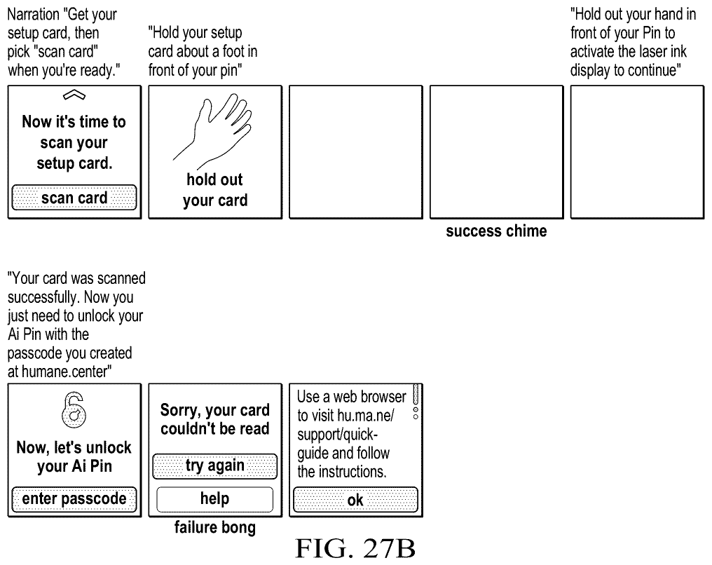

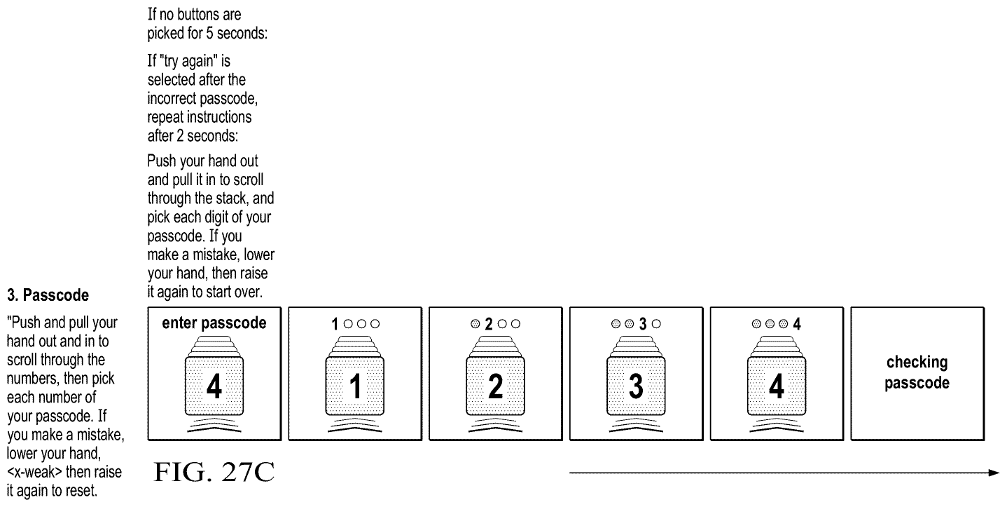

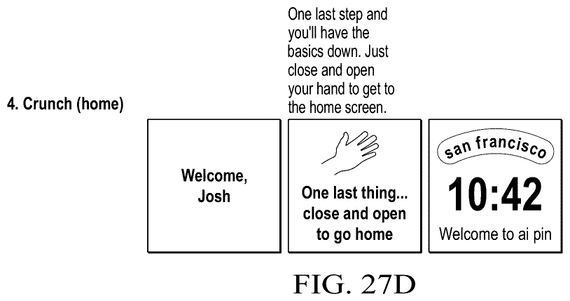

FIGS. 27A-27D show examples of menu navigation related to an “out of box” initialization process, according to one or more embodiments. The process includes a first boot procedure using the laser projector and tutorials using the laser projector for key gestures, such as tilt and roll, pincer and push back, push in and crunch gesture.

A number of implementations have been described. Nevertheless, it will be understood that various modifications may be made. Elements of one or more implementations may be combined, deleted, modified, or supplemented to form further implementations. In yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
detecting, using a first machine learning model, a three-dimensional (3D) image of a hand based on depth images of the hand;
predicting, using a second machine learning model, keypoints on the hand;
estimating, based on the keypoints and depth images, a normal to a palm of the hand;
computing a difference between the estimated normal and a resting normal;
projecting the difference into a two-dimensional (2D) plane of an ephemeral user interface projected on the user's hand palm;
focusing an underlying cursor on an affordance in the ephemeral user interface based on a location of the projected difference in the 2D plane;
detecting a gesture made by the user's hand; and
responsive to detecting the gesture, selecting the affordance.

2. A method comprising:
projecting an ephemeral user interface onto a hand palm, the ephemeral user interface including a first set of affordances;
detecting a change in depth of the hand palm relative to a depth sensor; and
responsive to the change in depth, projecting a second set of affordances in the ephemeral user interface.

3. A method comprising:
projecting a virtual stack of elements on a hand palm with a first element in the stack displaying a first value;
detecting a change in depth of the hand palm relative to a depth sensor; and
responsive to the change in depth, replacing the first element with a second element of the stack displaying a second value.
